(19) United States
(12) Patent Application Publication
(10) Pub. No.: US 2013/0227865 A1
(43) Pub. Date: Sep. 5, 2013

(54) DOUBLE LAYER POSTCARD

(71) Applicant: Carmine Mastalia, Roma (IT)

(72) Inventor: Carmine Mastalia, Roma (IT)

(73) Assignee: MAF DI MASTALIA ANELLA & C. SAS, Salerno (IT)

(21) Appl. No.: 13/885,075

(22) PCT Filed: Nov. 12, 2010
(86) PCT No.: PCT/IT2010/000453

§ 371 Date: May 13, 2013

(51) Int. Cl. B42D 15/04

(52) U.S. Cl. CPC B42D 15/042
USPC 40/124.11

(57) ABSTRACT

A postcard having at least one first part and one second part, set alongside one another, where the first part can be folded like a book on said adjacent second part so as to be superimposed on the latter covering it completely, and wherein the first part is provided with portions of area that can be glued on the second part and can be removed by tearing, thus obtaining that the inner surfaces not involved by the glue of the two parts that are glued to one another can be dedicated to the information and/or messages that the sender wishes to transfer to the addressee, with guarantee of confidentiality and evidence of any possible attempts at tampering.

The present invention relates to the sector of paper-processing industry and in particular regards a double-layer postcard, i.e., a postcard constituted by two parts folded on one another and provided with one or more tabs for gluing along the edges, where at least one part, or a portion thereof, which provided for personal messages of the sender or for information reserved to the addressee, is visible only after said tabs have been torn or removed.

Currently present on the market are postcards divided into three parts, of which one can be folded like a book and can be glued on the adjacent one in such a way that the information appearing on the surfaces that remain on the inside are not visible, and simultaneously only the remaining part of the postcard, purposely dedicated to the data of the addressee (name and address) as well as to the stamp(s), remains in view.

A drawback of said postcards is that it suffices to raise even only partially the part folded like a book in order to access the information appearing on the underlying layer, and then glue again and thus prevent any evidence of tampering from being discovered.

Consequently, the task of the present invention is to overcome the above drawback by providing a postcard that enables the sender to use as reserved area even the entire inner surface of the postcard, which corresponds to the one represented by the two surfaces that are to be glued, with the exclusion of purposely provided areas of gluing of limited dimensions that have the purpose of highlighting any attempt at tampering.

Said task is achieved by providing a postcard comprising at least two parts set alongside one another, where one of said parts can be folded like a book on the other so as to be superimposed completely on the latter, and can be glued thereon, along areas Of gluing provided on lateral tabs that can be removed by tearing, thus hiding from view the area reserved to the message of the sender for the addressee.

It is possible to envisage a space for the data of the addressee as well as for the stamp(s) on any of the two outer faces of the postcard.

Advantageously, the areas of gluing provided on the tabs enable the parts in contact to remain well attached until the-postcard is delivered, without any risk of the contents becoming accidentally visible or of somebody managing to peep into the two parts folded on top of one another as could happen if even only one side of the part folded like a book were open.

According to a variant of the invention, areas of gluing on the long sides are absent, but the top part of the postcard that is folded like a book on the remaining part is glued along approximately half its width starting from the line of folding as far as a pre-set perforation line, whilst a further area of gluing is provided at its opposite end on a tear-away tab. In this way, the portion of the top part of the postcard comprised between said perforation line and said tear-away tab can be detached from the rest, thus enabling the user to preserve, in smaller dimensions, the information provided on the non-visible face.

A better understanding of the invention will be obtained from the ensuing detailed description and with reference to the attached drawings, which illustrate, purely by way of example, some preferred embodiments.

In the drawings:

FIG. 1 is a top plan view of a first embodiment of the postcard forming the subject of the invention in the open configuration;

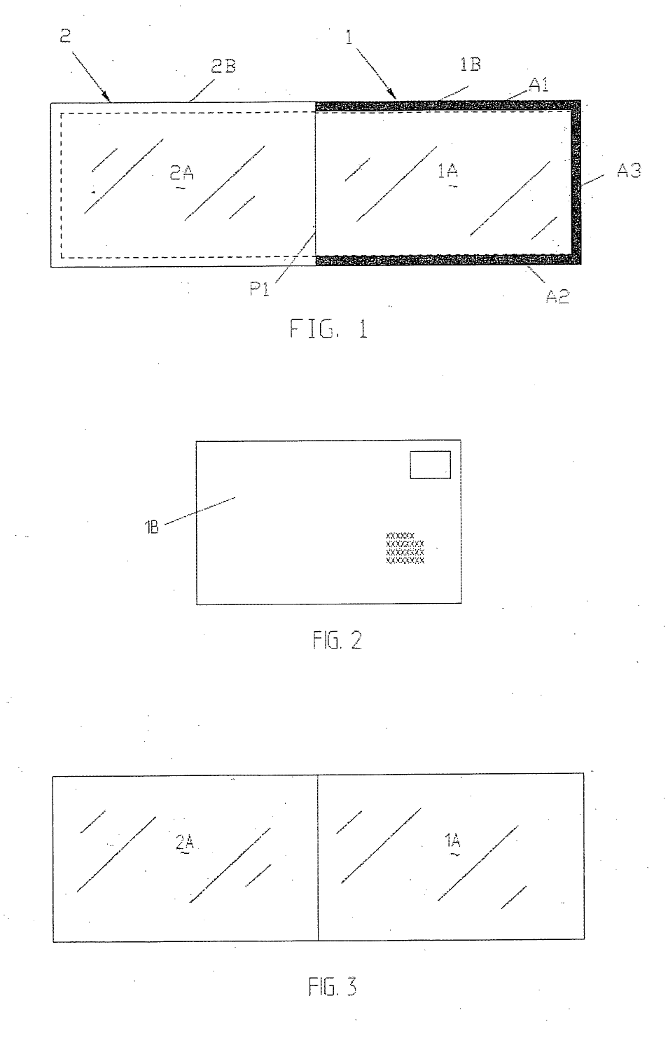

FIG. 2, similar to previous figure, shows the postcard in the closed configuration;

FIG. 3 shows the postcard open for reading the contents thereof;

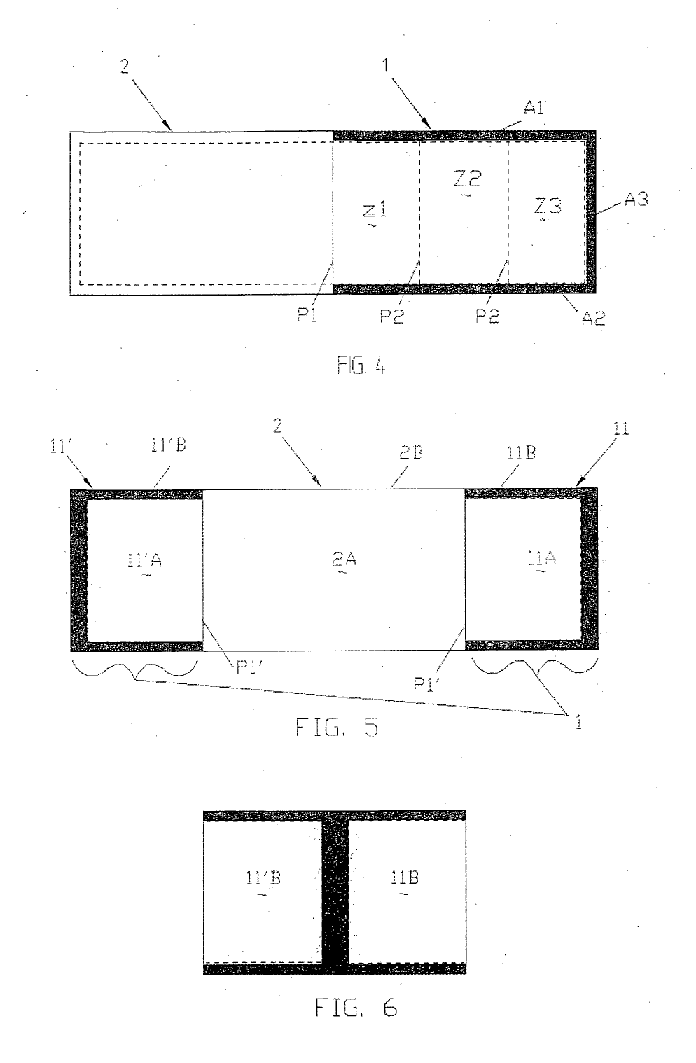

FIG. 4 is a top plan view of a variant of the postcard of FIG. 1;

FIG. 5 is a top plan view of a second embodiment of the postcard in the open configuration;

FIG. 6, which is similar to the previous one, shows the postcard in the closed configuration;

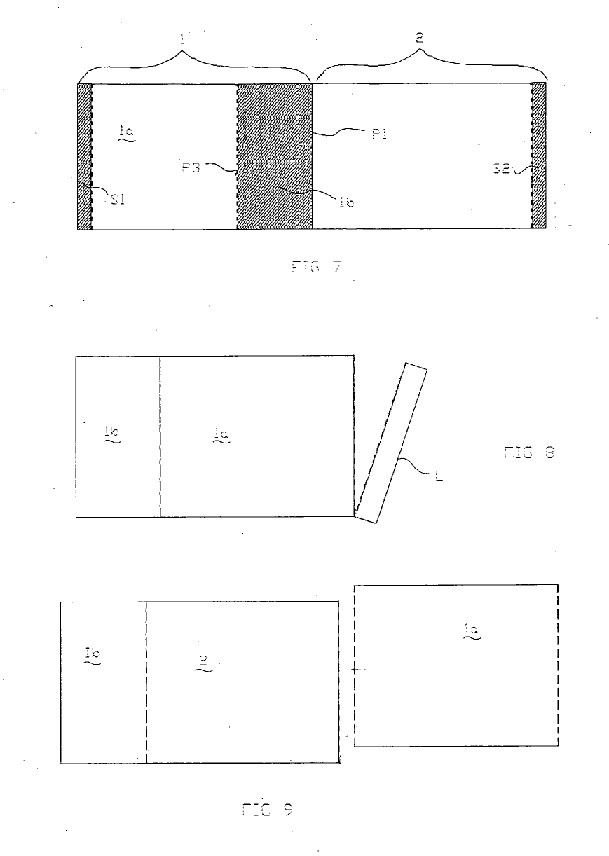

FIG. 7 shows another embodiment of the invention in the open configuration, where the area of gluing involves approximately half of the top part of the postcard and the remaining part can be separated by means of a tear-away tab with guarantee of. confidentiality;

FIG. 8 shows the same variant of FIG. 7 in the closed configuration with the tab partially torn away for accessing the contents present inside; and

FIG. 9 shows the postcard of FIG. 8 once the tab has been torn away and the removable portion has been released.

With reference to FIGS. 1 and 2, in the first embodiment that is described, a postcard is illustrated comprising two parts set alongside one another and having the same size: a first part 1 and a second part 2, in which the first part 1 can be folded like a book on said second part 2 so as to be completely superimposed on the latter and can be glued thereto.

Each of said parts 1 and 2 is provided, respectively, with an inner surface 1A and 2A reserved to the information and/or messages of the sender for the addressee and with an outer surface 1B and 2B, opposite, respectively, to the inner surface 1A and 1B. Provided on one of the outer surfaces is a space for the data of the addressee and the stamp(s).

In the example that is described, the space for the data of the addressee and the stamp(s) is set on the outer surface 1B.

In order to enable the first part 1 to be folded like a book on the adjacent second part 2, between said first part 1 and said second part 2 a transverse folding line P1 is provided.

In order to glue the parts 1 and 2 of the postcard together so that it will not be possible to view the contents of the postcard itself without damaging it, a plurality of perimetral areas of gluing is provided, which can be positioned on one or both of the inner surfaces 1A and 2A.

In the example described, the surface 1A is provided with three perimetral areas of gluing A1, A2 and A3, which can be separated by being detached from the postcard thanks to purposely provided perforation lines: a top horizontal area A1, a bottom horizontal area A2, and a vertical lateral area A3 at its free end.

Each area of gluing is provided with glue or an adhesive strip.

It is preferable to envisage also on the surface 2A further perforation lines corresponding to those present on the surface 1A.

It should be noted that it is also possible to provide one area of gluing on an inner surface of the postcard and the remaining two areas of gluing on the other inner surface in such a way that said areas are complementary to one another so as to seal the postcard. on each side.

FIG. 2 shows the postcard ready for being posted, with the two parts 1 and 2 glued together.

The person who will receive the postcard will simply have to open it, tearing away the areas of gluing.

FIG. 3 shows the postcard open with the contents visible, in which the areas of gluing A1, A2, and A3 have been removed.

In a variant shown in FIG. 4, at least one of the two parts 1 or 2 of the postcard can be divided into two or more portions by means of one or more transverse perforation lines P2, which enable said portions to be separated by being detached from the rest of the postcard.

In the variant described, the first part 1 is divided into three portions by means of two transverse perforation lines P2: a first, inner, portion Z1 adjacent to the second part 2; a second, central, portion Z2; and a third, outer, portion Z3 at the free end of the postcard.

Consequently, the central portion Z2 and outer portion Z3 can be separated by being detached from the rest of the postcard.

In a further variant, not shown in the figures, it is possible to envisage that also the transverse folding line P1 is a perforation line. In this way, it is possible to separate by detachment also the first portion Z1 or else separate by detachment directly the first part 1 from the second part 2.

A second embodiment of the postcard, shown in FIGS. 5 and 6, differs from the first embodiment in that said first part 1 designed to be folded like a book on the second part 2 is divided into two portions 11 and 11′, which have a size substantially equal to half of the second part 2 and are set at the two sides of the latter, which is hence set in the centre.

Consequently, the postcard is divided into three parts: a central part 2, and two side parts 11 and 11′, which can be folded like a book on the central one 2 so as to cover it completely.

Each of said side parts 11, 11′ is provided, respectively, with an inner surface 11A, 11′A, reserved to the message of the sender for the addressee, and an outer surface 11B, 11′B, opposite to the respective inner surface 11A, 11′A. It is possible to envisage a space for the data of the addressee and the stamp(s) on one of said outer surfaces 11B or 11′B or on the outer surface 2B of the central part 2.

In the example shown, provided between said side parts 11 and 11′ and said central part 2 is respective transverse line of folding P1′.

It is preferable for said transverse lines of folding P1′ to be perforation lines to enable said side parts 11 and 11′ to be separated by being detached from the second part 2.

A further variant is illustrated in FIGS. 7 to 9.

It differs from the first embodiment in that said first part 1 designed to be folded like a book according to the line P1 on the second part 2 is divided into two portions 1a and 1b by a perforation line P3. The entire area of the part 1b is provided with adhesive so as to be glued on the corresponding area of the part 2 at the moment of closing. Moreover provided are another two areas of gluing on the two short sides along two strips that can be separated by being torn away, which are designated respectively by S1 and S2 and which, being joined together, constitute a tab L removable at the moment of opening.

By tearing the tab L, the portion la can be raised from the underlying part 2 and separated from the portion 1b once again by tearing along the perforation line P3. This enables a coupon to be obtained appearing on which are the data reserved for the addressee.

The present invention has been described and illustrated according to some preferred embodiments, but it is understood that modifications and/or equivalent replacements may be made by any person skilled in the branch, without thereby departing from the sphere of protection of the present industrial patent right.

1. A postcard, comprising at least one first part and one second part set alongside one another, where said first part can be folded like a book on said adjacent second part so as to be superimposed on the latter covering it completely, and wherein said first part is provided with portions of area that can be glued on the second part, thus obtaining that the inner surfaces not involved by the glue of the two parts that are glued together can be dedicated entirely to the written information and/or messages that the sender wishes to transfer to the addressee, with guarantee of confidentiality and evidence of any possible attempts at tampering.

2. The postcard according to claim 1 wherein each of said parts is provided, respectively, with an inner surface reserved to the information and/or messages of the sender for the addressee, as well as with an outer surface, opposite to the corresponding inner surface; said space for the data of the addressee and the stamp(s) being provided on one of said outer surfaces of the postcard.

3. The postcard according to claim 1, wherein provided between the first part and the second part is a transverse line of folding, which enables the first part to be folded like a book on the adjacent second part.

4. The postcard according to claim 1 wherein at least one of the parts is provided with one or more transverse perforation lines for enabling said part to be divided into one or more portions that can be separated by detachment from the rest of the postcard.

5. The postcard according to claim 4, wherein the first part is provided with two transverse perforation lines that divide said first part into three portions, a first, inner, portion, adjacent to the second part, a second, central, portion, and a third, outer, portion at the free end of the postcard, wherein said second portion and said third portion can be separated by being detached from the postcard.

6. The postcard according to claim 3, wherein the transverse line of folding is a perforation line; thus obtaining that it is possible to separate by detachment the first part from the second part.

7. The postcard according to claim 2 provided within at least one of the two parts are three perimetral areas of gluing which can be separated by being detached from the postcard: a top horizontal area, a bottom horizontal area, and a vertical lateral area at its free end.

8. The postcard according to claim 7 wherein said areas of gluing are delimited by perforation lines.

9. The postcard according to claim 8 wherein the part of the postcard opposite to the one provided with said areas of gluing is provided with further perforation lines corresponding to those that delimit the areas of gluing.

10. The postcard according to claim 7, wherein each area of gluing is provided with glue or with an adhesive strip.

11. The postcard according to claim 1, wherein said first part is divided into two portions, which have a size substantially equal to half of the second part and are set at the two sides of said second part, thus obtaining that said postcard is divided into three parts, i.e., the second, central, part, and the two lateral portions that can be folded like a book on said second, central, part.

12. The postcard according to claim 11 wherein each of said lateral portions is provided with a respective inner surface reserved to the message of the sender for the addressee and with an outer surface, opposite to the respective inner surface.

13. The postcard according to claim 11, wherein provided between said lateral portions and said second, central, part is a respective transverse line of folding.

14. The postcard according to claim 13, wherein each of said transverse lines of folding is a perforation line; thus obtaining that it is possible to separate by detachment said lateral portions from the second part.

15. The postcard according to claim 1, wherein the first part is provided with a transverse perforation line, which divides said first part into two portions, a first portion, which constitutes entirely an area of gluing to be affixed on the second part, and a second portion, provided at its lateral free end, with a vertical lateral gluing strip, which, when the postcard is closed, is superimposed on a corresponding lateral gluing strip, set at the free end of the part so as to obtain a tear-away tab, thus obtaining that it is possible to detach the portion bearing the confidential data.
